(19) United States
(12) Patent Application Publication
(10) Pub. No.: US 2024/0324645 A1
(43) Pub. Date: Oct. 3, 2024

(54) COMPOSITIONS AND CONSUMABLES INCLUDING SAME

(71) Applicant: GIVAUDAN SA, VERNIER (CH)

(72) Inventors: Mariaelena Zuniga HAYES, Cincinnati, OH (US); Vijay MARRY, Cincinnati, OH (US)

(21) Appl. No.: 18/698,892

(22) PCT Filed: Oct. 10, 2022
(86) PCT No.: PCT/EP2022/078122

§ 371 Date: Apr. 5, 2024

Related U.S. Application Data
(60) Provisional application No. 63/254,831, filed on Oct. 12, 2021.

(51) Int. Cl. A23L 33/165; A23C 11/10; A23J 3/16; A23J 3/18; A23L 27/00; A23L 27/20

(52) U.S. Cl. CPC A23L 33/165; A23C 11/103; A23J 3/16; A23J 3/18; A23L 27/206; A23L 27/88

(57) ABSTRACT

A composition that provides at least the same amount of bioavailable calcium to a non-dairy consumable as a dairy consumable on a weight-by-weight basis without an unpleasant taste and mouthfeel, and to consumables containing such compositions. Also disclosed is a method of imparting a flavor and mouthfeel reminiscent of dairy to a non-dairy consumable.

### TECHNICAL FIELD

The present disclosure relates to compositions that provide at least the same amount of bioavailable calcium to a non-dairy consumable as a dairy consumable on a weight-by-weight basis while also providing a taste and mouthfeel reminiscent of a dairy consumable. The present disclosure also relates to improved calcium fortified dairy-alternative consumables and methods of preparing the same.

### BACKGROUND

Consumables such as foods and beverages are often modified to enhance nutritional properties. Nutritional fortification of consumables may include supplementation with nutrients that benefit the overall state of health of the human body. Examples of nutritional fortification include supplementation by vitamins, minerals, and comparable materials. These supplements are either essential for human metabolism or enhance the provision of substances that may not be available in sufficient amounts in a normal diet.

Calcium is one such essential nutrient. Calcium is a major structural constituent of bones in the human skeleton, and plays a significant role in electrophysiological processes, cell signaling, and as a cofactor for extracellular enzymes and regulatory proteins. Calcium is essential for many bodily functions, so a deficiency can have widespread effects, including on muscles, bones, and teeth, as well as on mental health. Calcium deficiency is also associated with an increased risk of hypertension, preeclampsia, and colon cancer in adults. Long-term calcium deficiency can lead to dental changes, cataracts, alterations in the brain, and osteoporosis.

Consumer demand for plant-derived products composed of “clean label” ingredients has been growing in recent years. With increasing popularity of plant-derived and vegan diets, as well as increasing diagnosis of dairy allergies in children and adults alike, the demand for healthy and natural dairy-alternative products has been on the rise.

While the industry is beginning to deliver as much protein in dairy-alternative products as their dairy counterparts, delivering as much calcium as dairy products has been more challenging due to poor solubility, poor bioavailability, and unpleasant flavor off-notes inherent to known compositions. Due to their poor solubility in water, they deliver an undesirable mouthfeel, such as grittiness, to a consumables sensory profile. Therefore, there is a need for compositions that provide at least the same amount of bioavailable calcium to a non-dairy consumable as a dairy product on a weight-by-weight basis without the unpleasant taste and mouthfeel associated with known compositions.

### SUMMARY

In one illustrative embodiment, a composition comprises (a) at least one inorganic salt and/or inorganic chelate of calcium with potassium citrate and (b) at least one organic acid, wherein the composition is free of animal-derived ingredients, wherein the composition provides at least the same amount of bioavailable calcium to a non-dairy consumable as a dairy consumable on a weight-by-weight basis while also providing a taste and mouthfeel reminiscent of a dairy consumable.

In another illustrative embodiment, a non-dairy consumable comprises an edible non-animal protein base and a composition comprising (a) at least one inorganic salt and/or inorganic chelate of calcium with potassium citrate and (b) at least one organic acid, wherein the composition and the consumable are both free of animal-derived ingredients, wherein the consumable provides at least the same amount of bioavailable calcium to a non-dairy consumable as a dairy consumable on a weight-by-weight basis while also providing a taste and mouthfeel reminiscent of a dairy consumable.

According to further illustrative embodiments, a non-dairy beverage comprises a beverage base, plant-derived protein, and a composition comprising (a) at least one inorganic salt and/or inorganic chelate of calcium with potassium citrate and (b) at least one organic acid, wherein the composition and the non-dairy beverage are both free of animal-derived ingredients, wherein the non-dairy beverage provides a taste and mouthfeel reminiscent of a dairy beverage, and wherein the non-dairy beverage provides at least the same amount of bioavailable calcium as a dairy beverage on a weight-by-weight basis.

According to further illustrative embodiments, disclosed is a method for preparing a plant-derived, non-dairy consumable comprising adding to a consumable base plant-derived protein and a composition comprising (a) at least one inorganic salt and/or inorganic chelate of calcium with potassium citrate, (b) at least one organic acid, and optionally at least one of: a flavorant, a non-animal fat, a sweetener, or a carbohydrate component.

According to further illustrative embodiments, disclosed is a method for preparing a calcium-fortifying composition that is free of animal-derived ingredients comprising adding (a) at least one inorganic salt and/or inorganic chelate of calcium with potassium citrate, (b) at least one organic acid, and optionally at least one of: a flavorant, a non-animal fat, a sweetener, a plant-derived protein, or a carbohydrate component to form the composition.

In yet another embodiment, a method of modifying taste or mouthfeel of a plant-derived, non-dairy consumable comprising non-animal derived protein, wherein the method provides a taste and mouthfeel reminiscent of a dairy consumable, wherein the method comprises adding to a plant-derived, non-dairy consumable base a composition comprising (a) at least one inorganic salt and/or inorganic chelate of calcium with potassium citrate and (b) at least one organic acid, wherein the composition is free of animal-derived ingredients.

In yet a further embodiment, a method of imparting a taste or mouthfeel reminiscent of dairy to a non-dairy consumable, the method comprising the step of incorporating into a non-dairy consumable a composition comprising (a) at least one inorganic salt and/or inorganic chelate of calcium with potassium citrate and (b) at least one organic acid, wherein the composition is free of animal-derived ingredients.

According to further illustrative embodiments, disclosed is the use of a composition comprising (a) at least one inorganic salt and/or inorganic chelate of calcium with potassium citrate and (b) at least one organic acid to improve the taste and mouthfeel of a plant-derived, non-dairy consumable.

These and other features, aspects and advantages of specific embodiments will become evident to those skilled in the art from a reading of the present disclosure.

### DETAILED DESCRIPTION

The following text sets forth a broad description of numerous different embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims.

The present disclosure is based on the surprising discovery that a composition comprising (a) at least one inorganic salt and/or inorganic chelate of calcium with potassium citrate and (b) at least one organic acid, incorporated into a plant-derived, non-dairy consumable, improves the taste and mouthfeel profile of the consumable. A plant-derived. non-dairy consumable containing the composition was found to possess a taste and mouthfeel reminiscent of a dairy product, which could not be achieved by other compositions known in the art. Even more surprising was the finding that the composition provides at least the same amount of bioavailable calcium to a non-dairy consumable as a dairy consumable on a weight-by-weight basis.

As used herein, the term “taste” is used to describe the sensory response related to taste receptors. The quality of taste may be expressed as the interplay of descriptors. For example. “juicy”, associated with mouthfeel of a 100% juice beverage: “sour”, associated with acids in solution: “pulpy”, associated with pulp in a fresh squeezed orange juice; and “peely”, associated with the peel and skin of citrus fruits. This list of descriptors is not limitative and descriptors may change depending on the nature of the composition.

Mouthfeel (or “mouth feel”) refers to the physical sensations experienced or felt in the mouth that are created by food and beverages, or compositions added to food or beverages. Mouthfeel may refer to textures that come into contact with the tongue, roof of the mouth, teeth, gums, or throat. Mouthfeel is considered to be distinct from taste/flavour, but is considered to have an equal or even greater impact on a person's enjoyment or preference for certain foods over others. Although not strictly a flavour characteristic, mouthfeel can add—or detract—considerably from a comestible composition. An undesirable mouthfeel can be seriously disadvantageous to an otherwise desirably-flavoured composition. Typical mouthfeel descriptors used to describe perceived sensations include acidity (metallic, citrusy, bright), density (close, airy), dryness (arid, scorched), graininess (particulate, powdery, dusty, grainy, chalky), gumminess (chewy, tough), hardness (crunchy, soft), heaviness (full, weighty), irritation (prickly, stinging), mouth coating (oily, buttery), roughness (abrasive, textured), slipperiness (slimy, stringy), smoothness (satiny, velvety), uniformity (even, uneven) and viscosity (full-bodied, light-bodied).

According to the present disclosure, the composition comprises (a) at least one inorganic salt and/or inorganic chelate of calcium with potassium citrate and (b) at least one organic acid, wherein the composition is free of animal-derived ingredients, wherein the composition provides a taste and mouthfeel reminiscent of a dairy product, when incorporated into a plant-derived, non-dairy consumable, and wherein the composition provides at least the same amount of bioavailable calcium to a non-dairy consumable as a dairy consumable on a weight-by-weight basis.

The compositions of the present disclosure may be used in a wide variety of consumables or applications and is not restricted to any particular physical mode or product form. According to the present disclosure, the term “consumable” refers to products for consumption by a subject, typically via the oral cavity (although consumption may occur via non-oral means such as inhalation), for at least one of the purposes of enjoyment, nourishment, or health and wellness benefits. Consumables may be present in any form including, but not limited to, liquids, solids, semi-solids, tablets, capsules, lozenges, strips, powders, gels, gums, pastes, slurries, syrups, aerosols and sprays. The term also refers to, for example, dietary and nutritional supplements. Consumables include compositions that are placed within the oral cavity for a period of time before being discarded but not swallowed.

Component (a) of the composition, namely, at least one inorganic salt and/or inorganic chelate of calcium with potassium citrate, should be present in the composition in a nutritionally and organoleptically effective amount. In certain embodiments, component (a) is present in the composition in an amount of at least 0.1%, or at least 1%, or at least 5% or at least 20%, or at least 30%, or at least 40%, or at least 50%, or at least 60%, or at least 70%, or at least 80%, or at least 90%, or at least 95%, based on the total weight of the composition. In certain embodiments, component (a) is present in the composition in an amount of about 1% to about 20% based on the total weight of the composition. In certain embodiments, component (a) is present in the composition in an amount of about 3% to about 15% based on the total weight of the composition. In certain embodiments, component (a) is present in the composition in an amount of about 5% to about 10% based on the total weight of the composition.

In certain embodiments, the at least one inorganic salt and/or inorganic chelate of calcium comprises calcium phosphate. In certain embodiments, the calcium phosphate is monocalcium phosphate, dicalcium phosphate, and/or tricalcium phosphate. In certain embodiments, the at least one inorganic salt and/or inorganic chelate of calcium with potassium citrate is calcium potassium phosphate citrate. In certain embodiments, the at least one inorganic salt and/or inorganic chelate of calcium with potassium citrate comprises 18-25% calcium, 15-20% potassium, 50-60% citric acid, and 9-15% phosphorus. In certain embodiments, the at least one inorganic salt and/or inorganic chelate of calcium with potassium citrate comprises about 18% calcium, about 15% potassium, about 57% citric acid, and about 9% phosphorus. In certain embodiments, the at least one inorganic salt and/or inorganic chelate of calcium with potassium citrate comprises about 18% calcium.

The composition further comprises at least one organic acid. The at least one organic acid may be selected from group consisting of citric acid, malic acid, fumaric acid, tartaric acid, lactic acid, ascorbic acid, oxalic acid, malonic acid, uronic acid, quinic acid, succinic acid, levulinic acid and mixtures thereof. In one embodiment, the at least one organic acid is selected from the group consisting of succinic acid, acetic acid, lactic acid, propionic acid, and mixtures thereof. Suitable organic acids are available from Givaudan Flavors Corporation of Cincinnati, Ohio.

It has been found that incorporating the composition comprising (a) at least one inorganic salt and/or inorganic chelate of calcium with potassium citrate and (b) at least one organic acid into a plant-derived, non-dairy consumable achieves a taste and mouthfeel reminiscent of a dairy consumable. In certain embodiments, the composition comprises at least two of: succinic acid, acetic acid, lactic acid or propionic acid. In certain embodiments, the composition comprises at least three of: succinic acid, acetic acid, lactic acid or propionic acid. In certain embodiments, the composition comprises at least one organic acid in an amount of at least 0.1%, or at least 1%, or at least 2%, or at least 5%, or at least 10%, or at least 20%, or at least 30%, or at least 40%, or at least 50%, based on the total weight of the composition. In certain embodiments, the composition comprises at least one organic acid in amount of about 1% to about 20%, or in an amount of about 2% to about 15%, or in an amount of about 3% to about 10%, or in an amount of about 4% to about 8%, based on the total weight of the composition.

The composition may be used as a partial or complete replacement of other calcium salts. In certain embodiments, the composition is free of calcium salts other than the at least one inorganic salt and/or inorganic chelate of calcium with potassium citrate. In certain embodiments, the composition is free of calcium ascorbate, calcium carbonate, calcium sulfate, calcium lactate, calcium lactate gluconate, calcium acetate, calcium chloride, and/or calcium hydroxide.

The composition may further comprise at least one flavourant. By “flavourant” it is meant a composition created by a flavourist using methods known to the skilled person that is a mixture of tastants, aroma compounds and/or sensates. Examples of suitable flavourants include natural flavours, artificial flavours, spices, seasonings, and the like. Exemplary flavourants include synthetic flavour oils and flavouring aromatics and/or oils, oleoresins, essences, and distillates, and a combination comprising at least one of the foregoing. Generally, any flavourant or food additive such as those described in “Chemicals Used in Food Processing”, Publication No 1274, pages 63-258, by the National Academy of Sciences, can be used.

Flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil: useful flavoring agents include artificial, natural and synthetic fruit flavors such as vanilla, and citrus oils including lemon, orange, lime, grapefruit, yuzu, sudachi, and fruit essences including apple, pear, peach, grape, raspberry, blackberry, gooseberry, blueberry, strawberry, cherry, plum, prune, raisin, cola, guarana, neroli, pineapple, apricot, banana, melon, apricot, cherry, tropical fruit, mango, mangosteen, pomegranate, papaya, and so forth.

Additional exemplary flavors imparted by a flavorant include a milk flavor, a butter flavor, a cheese flavor, a cream flavor, and a yogurt flavor, a vanilla flavor, tea or coffee flavors, such as a green tea flavor, an oolong tea flavor, a tea flavor, a cocoa flavor, a chocolate flavor, and a coffee flavor: mint flavors, such as a peppermint flavor, a spearmint flavor, and a Japanese mint flavor: spicy flavors, such as an asafetida flavor, an ajowan flavor, an anise flavor, an angelica flavor, a fennel flavor, an allspice flavor, a cinnamon flavor, a chamomile flavor, a mustard flavor, a cardamom flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, and a wasabi (Japanese horseradish) flavor: a nut flavor such as an almond flavor, a hazelnut flavor, a macadamia nut flavor, a peanut flavor, a pecan flavor, a pistachio flavor, and a walnut flavor: floral flavors; and vegetable flavors, such as an onion flavor, a garlic flavor, a cabbage flavor, a carrot flavor, a celery flavor, mushroom flavor, and a tomato flavor. Suitable flavours are available from Givaudan Flavors Corporation of Cincinnati, Ohio.

The flavourant may be a liquid, gel, colloid, or particulate solid, for example, an oil, an extract, an oleoresin, or the like. In certain embodiments, flavourants may include any one or more food-grade flavourants that do not substantially dissolve in water. In certain embodiments, the composition and/or consumable comprises at least one non-aqueous flavourant.

The composition may include a sufficient amount of the at least one flavourant to impart a desired level of flavour or taste. In certain embodiments, the composition comprises at least one flavourant in amount of about 0.01% to about 20%, or in an amount of about 0).1% to about 10%, or in an amount of about 1% to about 5%, based on the total weight of the composition. A single flavourant or combinations of two or more flavourants may be included in the composition to prepare a variety of consumable products having different flavours or tastes.

According to certain embodiments, the at least one flavourant is combined with a suitable emulsifier in an amount effective to form an emulsion. In certain embodiments, the composition comprises at least one emulsifier in an amount of at least 1%, or at least 2%, or at least 5%, or at least 10%, or at least 20%, or at least 30%, or at least 40%, or at least 50% by weight of the composition. In certain embodiments, the composition comprises at least one emulsifier in an amount of about 0.01% to about 20%, or in an amount of about 0).1% to about 10%, or in an amount of about 1% to about 5%, based on the total weight of the composition. Any emulsifier that is generally regarded as safe (GRAS) for inclusion in a consumable that is intended for human or pet consumption, and that is capable of emulsifying a flavourant to create the emulsion, may be used as an emulsifier for preparing the composition or consumable. In some cases, the flavourant may be emulsified without the need for any emulsifiers.

The emulsifiers may be anionic emulsifiers, cationic emulsifiers, non-ionic emulsifiers and amphoteric emulsifiers. Without limitation, and only by way of illustration, suitable emulsifiers include celluloses, monoglycerides, diglycerides, acylated monoglycerides, lactylated monoglycerides succinylated monoglycerides, alkoxylated monoglycerides (such as ethoxylated monoglycerides), alkoxylated diglycerides (such as ethoxylated diglycerides), esters of monoglycerides (such as diacetyl tartaric acid esters of monoglycerides), lethicins (such as soy lecithin and lecithin from egg yolk), modified food starches, gum arabic, octenyl succinic anhydride (OSA) starch, starch sodium octenyl succinate, Quillaya saponins, magnesium stearate, calcium, potassium and sodium salts of fatty acids, polysorbates, alkali metal stearoyl lactylate (such as sodium stearoyl lactylate), beta glucans, sugar esters, alkaline earth metal stearoyl lactylate (such as calcium stearoyl lactylate), sodium phosphates and mixtures thereof. In certain embodiments, the emulsifier is derived from sorbitan.

The composition and/or consumable may also include other optional ingredients. For example, the composition and/or consumable may include at least one of: a stabilizer, an emulsifier, a preservative, a starch, non-animal fat, a protein binder, a stabilizer, a mouthfeel improving agent, a vitamin, amino acids, a probiotic, a prebiotic, a taste modifier, a functional ingredient, a vegetable oil, an antioxidant, a carrier, a flowing agent, or a sweetener.

The composition may include at least one sweetener in a sweetening-effective amount to impart a desired sweetness to the composition and the resulting consumable to which the composition is added. The at least one sweetener may comprise at least one caloric sweetener, or at least one non-caloric sweetener, or a combination of at least one caloric sweetener and at least one non-caloric sweeteners. The non-caloric sweeteners may be selected from synthetic non-caloric sweeteners and natural non-caloric sweeteners.

Without limitation, and only by way of illustration, suitable synthetic non-caloric sweeteners include acesulfame K, advantame, aspartame, cyclamate, neotame, neohesperidin dihydrochalcone, saccharin, sucrolose and combinations thereof.

Without limitation, and only by way of illustration, suitable non-caloric natural sweeteners include steviol glycosides selected from stevioside, rebaudioside A, rebaudioside B, rebaudioside C. rebaudioside D. rebaudioside E, rebaudioside F. rebaudioside G, rebaudioside H, rebaudioside I, rebaudioside J, rebaudioside K. rebaudioside L, rebaudioside M, rebaudioside N, rebaudioside O, dulcoside A, dulcoside B, rubusoside, and combinations thereof, mogrol glycosides selected from mogroside I, mogroside II, mogroside III, mogroside IV, mogroside V. isomogroside V. 11-oxomogroside, siamenoside I and combinations thereof, Luo Han Guo sweetener, Swingle Extract, erythritol, glycyrrhizic acid, thaumatin, brazzein, monatin and combinations thereof.

Without limitation, and only by way of illustration, suitable caloric sweeteners include sucrose, fructose, glucose, high fructose corn syrup, corn syrup, xylose, arabinose, rhamnose, erythritol, xylitol, mannitol, sorbitol, inositol and combinations thereof.

The composition may include beta glucan. The beta glucan may be present in the composition in the form of fibers. According to certain illustrative embodiments, the beta-glucan is selected from bacteria-derived beta-glucan, grain-derived beta-glucan, fungi-derived beta-glucan, yeast-derived beta-glucan, and combinations thereof. Suitable beta glucan is commercially available from Naturex SA and Swedish Oat Fiber Ab of Bua. Sweden under the designations SWEOAT™ Bran BG14, SWEOAT™ Bran BG22, and SWEOAT™ Bran BG28. In certain embodiments, the composition comprises beta glucan in an amount of about 0.001% to about 20%, or in an amount of about 0.1% to about 10%, or in an amount of about 0).2% to about 1%, or in an amount of about 0).3% to about 0.5%, based on the total weight of the composition.

Plant-based dairy alternative consumables have been experiencing double digit growth in recent years. Pea protein in particular is a low-cost source of plant protein. Current plant-based milks use gellan gum, or gellan gum in combination with locust bean gum or guar gum to deliver mouthfeel and prevent sedimentation. However, such gums are often not considered to be clean label ingredients. It has been found that including beta glucan into the composition or a consumable containing the composition provides a label-friendly soluble fiber, instead of a gum to deliver mouthfeel and suspend the solids in a liquid consumable. In addition, beta glucan provides a cholesterol lowering effect, that is not provided with the above-mentioned gums. In certain embodiments, the disclosed composition and/or consumable is free of gums, such as gellan gum, locust bean gum or guar gum.

The composition and/or consumable described herein may comprise a carbohydrate component. A variety of ingredients may be used as all or part of the carbohydrate component. That said, such ingredients are typically classified as a starch, a flour, or an edible fiber and the carbohydrate component may comprise one or more types of starch, flour, edible fiber, and combinations thereof. Examples of starch include wheat starch, corn starch, rice starch, oat starch, potato starch, and combinations thereof. Examples of flour include wheat flour, rice flour, white corn flour, oat flour, sorghum flour, rye flour, amaranth flour, quinoa flour, and combinations thereof.

Specific starches that may be used to prepare the composition and consumable include, without limitation, arrowroot starch, bean starch (such as, for example, fava beans, kidney beans, lentil beans, mung beans, and chickpeas), cassava starch, corn starch, oat starch, pea starch, potato starch (including both waxy potato starch and floury or mealy potato starch), quinoa, rice starch, tapioca starch, wheat starch, and mixtures thereof. According to certain embodiments, the starch is corn starch. According to certain embodiments, the starch is potato starch. According to certain embodiments, the starch is rice starch. According to certain embodiments, the starch is wheat starch. Suitable food grade potato starches are commercially available from Avebe (Veendam, The Netherlands) under the trademarks ELIANE™, ETENIA™, FARINEX™, PASELLI™, PERFECTAMYL™, and PURAMYL™. In certain embodiments, the composition comprises at least one carbohydrate component in an amount of about 20% to about 80%, or in an amount of about 40% to about 70%, or in an amount of about 50% to about 60%, based on the total weight of the composition.

According to certain embodiments, one or more plant derived proteins may be used in combination with the carbohydrate component, or as a replacement for the carbohydrate component, to prepare the composition or consumable. For example, and without limitation, the plant-derived protein may comprise algae (such as spirulina), beans (such as black beans, canelli beans, kidney beans, lentil beans, lima beans, pinto beans, soy beans, white beans, mung beans), broccoli, mycoprotein, nuts (such as almonds, brazil nuts, cashews, peanuts, pecans, hazelnuts, pine nuts, walnuts), peas (such as black eyed peas, chickpeas, green peas), potatoes, seeds (such as canola, chia, flax, hemp, pumpkin, sesame, sunflower), plant leaf proteins such as Rubisco, cereal (such as oatmeal, wheat, barley, spelt), corn, rice and mixtures thereof.

According to certain embodiments, the composition comprises a non-animal fat comprising solid fats, semi-solid fats, oils and combinations thereof. According to certain embodiments, the oils that may constitute the fat component of the composition comprise algal oils, insect oils, vegetable-derived oils and combinations thereof. The non-animal fat may include medium chain glycerides (MCT), saturated fatty acids, unsaturated fatty acids (mix of both). According to certain embodiments, the fat component of the composition comprises one or more vegetable-derived oils. Without limitation, and only by way of illustration, suitable vegetable oils that may be used to prepare the fat delivery systems include almond oil, avocado oil, canola oil, coconut oil, corn oil, cottonseed oil, flaxseed oil, hazelnut oil, illipe oil, linseed oil, palm oil, palm kernel oil, peanut oil, pecan oil, pumpkin seed oil, oat oil, olive oil, rapeseed oil, safflower oil, sesame oil, shea oil, soybean oil, sunflower oil, walnut oil, and mixtures thereof. In certain embodiments, the plant-based fat comprises an oil-in-water emulsion. In certain embodiments, the composition comprises at least one non-animal fat in an amount of about 1% to about 50%, or in an amount of about 5% to about 40%, or in an amount of about 10% to about 30%, or in an amount of about 15% to about 25% by weight of the composition. Without limitation, a suitable medium chain glyceride obtained from coconut oil is commercially available from Nutiva, Inc. of Richmond, California.

In certain embodiments, the composition comprises at least one protein binder. In some embodiments, a protein binder is selected based upon its ability to tie up or bind to the protein thus preventing the protein from binding to the flavorant. This ability to bind to the protein and “free-up” the flavorant is determined by a number of factors, including, for example, amino acid profile, protein confirmation, hydrophobicity, time of addition, behavior of protein during processing, type of characterizing flavorant(s) and polarity of flavorant(s). In certain embodiments, the composition comprises at least one protein binder in an amount of about 0.001% to about 20%, or in an amount of about 0.01% to about 10%, or in an amount of about 0.1% to about 5%, or in an amount of about 1% to about 2%, by weight of the composition.

In certain embodiments, the protein binder may include a mixture of at least one terpene and at least one carbonyl compound. In certain embodiments, the protein binder may include a mixture of a terpene and two or more carbonyl compounds. In one embodiment, suitable terpenes (isoprenoids and tetraterpenoids) include, but are not limited to, carotenes (such as, for example, alpha-carotene, beta-carotene, gamma-carotene, delta-carotene, lycopene, neurosporene, phytofluene, phytoene), and xanthophylls (such as, for example, canthaxanthin, cryptoxanthin, aeaxanthin, astaxanthin, lutein, rubixanthin): monoterpenes (such as, for example, limonene, perillyl alcohol): sesquiterpenes (such as, for example, caryophyllene, beta-caryophyllene, zingiberene): saponins: lipids including: phytosterols, campesterol, beta sitosterol, gamma sitosterol, stigmasterol), tocopherols (vitamin E), and omega-3, -6, and -9) fatty acids (such as, for example, gamma-linolenic acid): triterpenoids (such as, for example, oleanolic acid, ursolic acid, betulinic acid, moronic acid): alpha-pinenes, cis-beta-ocimenes and bisabolenes (such as alpha-bisabolene and gamma-bisabolene.

Suitable carbonyl compounds include ketones and aldehydes, including, but are not limited to, acetone, acetyl methyl carbinol, acetophenone, 2-butanone, L-carvone, D-carvone, diacetyl, 2-heptanone, beta-ionone. L-menthone, anisyl acetaone, methyl cyclopentenolone, methyl nonyl ketone, methyl heptenone, 2-nonanone, 2-octanone, 2-pentanone, 2-undecanonen, 4-hydroxy-2.5dimethyl-3 (2H)-furanone, nootkatone, tridecanone, tetradecalactone, decalactone, butyrolactone, 2-tridecanone, benzaldehyde, n-butyraldehyde, isobutraldehyde, cinnamic aldehyde, citronellal, decanal, docecenal, hexanal, aldehyde C-12, aldehyde C-8, acetaldehyde, trans-2-hexenal, anisyl aldehyde, trans 2-decenal, cis-3-hexenal and cis-4-heptenal.

The disclosed composition may be in the form of an emulsion, a solution or a powder. For example, it may be desirable or appropriate to add flavour ingredients that are oils, or are oil-soluble to a solution containing all water-soluble ingredients and emulsify the resultant mixture. The composition, in the form of an emulsion could then be further diluted in an aqueous phase, as necessary or appropriate. Alternatively, it might be desirable or appropriate to mix both oil and oil-soluble ingredients, and water-soluble ingredients with a compatible solvent or solvent system, such as propylene glycol, isopropanol, glycerol, ethanol, water, or mixtures thereof to form a composition in the form of a solution or dispersion, which can then be further diluted in an aqueous phase as necessary or appropriate.

In certain embodiments, the composition is present in a powder form that is configured to be reconstituted with water and optionally processed (e.g., subjected to ultrahigh temperature treatment, homogenized and packed).

According to certain illustrative embodiments, the at least one inorganic salt and/or inorganic chelate of calcium with potassium citrate and the at least one organic acid may be separately added as individual components to a consumable base formulation in nutritionally and organoleptically effective amounts of these additives. According to other embodiments, the at least one inorganic salt and/or inorganic chelate of calcium with potassium citrate and the at least one organic acid may be formulated into a composition, and the composition added to a consumable base formulation. In certain embodiments, the composition comprising the at least one inorganic salt and/or inorganic chelate of calcium with potassium citrate and the at least one organic acid is formulated to be incorporated into a dry powder beverage mix to be reconstituted with a drinkable liquid, such as water, to provide a non-dairy beverage. In certain embodiments, the composition comprising the at least one inorganic salt and/or inorganic chelate of calcium with potassium citrate and the at least one organic acid is incorporated into a liquid beverage mix to provide a non-diary beverage.

Also disclosed is a calcium-fortified plant-derived, non-dairy consumable comprising an edible non-animal protein base and a composition comprising at least one inorganic salt and/or inorganic chelate of calcium with potassium citrate and at least one organic acid, wherein the non-dairy consumable is free of animal-derived ingredients, wherein the non-dairy consumable provides a taste and mouthfeel reminiscent of a dairy consumable, and wherein the non-dairy consumable provides at least the same amount of bioavailable calcium as a dairy consumable on a weight-by-weight basis.

The plant-derived, non-dairy consumable comprises a consumable base, at least one plant-derived protein, and a composition comprising at least one inorganic salt and/or inorganic chelate of calcium with potassium citrate and at least one organic acid. The consumable may comprise a liquid beverage. The terms “beverage”, “beverage composition” and “beverage product” are used interchangeably herein to mean ready-to-drink beverages. beverage concentrates, beverage syrups, or powdered beverages.

According to certain illustrative embodiments, the at least one plant-derived protein is derived from peas and the at least one beta-glucan is a grain-derived beta-glucan. According to certain embodiments, the at least one plant-derived protein is derived from peas and the at least one beta-glucan is an oat-derived beta-glucan. According to certain embodiments, the at least one plant-derived protein is derived from peas and is present in a composition or dry powder beverage mix in the form of fibers and the at least one beta-glucan is an oat-derived beta-glucan and is present in the composition or dry powder beverage mix in the form of fibers.

According to certain embodiments, both the plant-derived protein and the beta-glucan are present in the composition and/or consumable in the form of fibers. According to certain embodiments, both the plant-derived protein and the beta-glucan are present in the composition and/or consumable in the form of fibers. According to certain embodiments, both the plant-derived protein and the beta-glucan are present in the dry powder beverage mix composition in the form of fibers. According to certain embodiments, both the plant-derived protein and the beta-glucan are present in a liquid beverage composition in the form of fibers.

Exemplary edible non-animal proteins that may be included in the composition and/or consumable are soy protein and pea protein. Without limitation, a suitable pea protein is commercially available from Ingredion Incorporated of Westchester, Illinois under the designation VITESSENCE®. As used herein, soy includes all consumables containing soy in any form, including soybean oil used either alone, in combination, for example as a nutraceutical, or as a medicament, soybean curd, soy milk, soy butter or soy paste. The plant protein may comprise algae (such as spirulina), beans (such as black beans, canelli beans, kidney beans, lentil beans, lima beans, pinto beans, soy beans, white beans), broccoli, edamame, mycoprotein, nuts (such abrocs almonds, brazil nuts, cashews, peanuts, pecans, hazelnuts, pine nuts, walnuts), peas (such as black eyed peas, chickpeas, green peas), potatoes, oatmeal, seeds (such as chia, flax, hemp, pumpkin, sesame, sunflower), seitan (i.e., wheat gluten-based), tempeh, tofu, and mixtures thereof. According to certain embodiments, the plant protein is a potato-derived protein. In another embodiment, the non-animal protein is selected from the group consisting of grain, legume, pulses, seed, oilseed, nut, algal, mycoprotein, fungal protein, insects, leaf protein and combinations thereof.

According to certain illustrative embodiments, the at least one plant-derived protein is derived from peas. Without limitation, the peas may be selected from black eyed peas, chickpeas, green peas and mixtures thereof.

In certain embodiments, the edible non-animal protein base comprises at least one of beans, broccoli, mycoprotein, nuts, coconuts, peas, potatoes, oats, seeds plant leaf proteins, cereal, or tofu. Without limitation, the beans may include at least one of black beans, faba beans, canelli beans, kidney beans, lentil beans, lima beans, pinto beans, soy beans, white beans, mung beans: the nuts comprise at least one of almonds, brazil nuts, cashews, peanuts, pecans, hazelnuts, pine nuts, walnuts: the peas comprise at least one of black eyed peas. chickpeas, green peas: the seeds comprise at least one of chia, flax, hemp, pumpkin, sesame, sunflower; and the cereal comprises at least one of oatmeal, wheat, barley, spelt. corn, rice.

Broadly, consumables include, but are not limited to, foodstuffs of all kinds, savoury products, confectionery products, baked products, sweet products, fermented products, dairy-alternative products, meat analogue products, beverages, oral care products, nutraceuticals and pharmaceuticals. According to certain embodiments, the consumable is a vegetarian food product. In other embodiments, the consumable is a vegan food product containing only plant-derived components and no animal-derived components.

Dairy-alternative products contain (instead of dairy protein derived from the milk of mammals) protein from botanical sources (soy, pea, etc.). Exemplary consumables include dairy-alternative products selected from the group consisting of milk, yoghurt, yoghurt beverage, smoothy, lassi, milk shake, ice cream, dessert, sour cream, dip, salad dressing, cottage cheese, soy milk, rice milk, soy drink, and rice milk drink.

Exemplary beverages include, but are not limited to, flavoured water, soft drinks, fruit drinks, coffee-based drinks, tea-based drinks, juice-based drinks (includes fruit and vegetable), non-dairy-based milk drinks, gel drinks, carbonated or non-carbonated drinks, powdered drinks, alcoholic or non-alcoholic drinks, and ready to drink liquid formulations of these beverages.

According to certain embodiments, the consumable is a product that can be considered to be a “clean-label” product. The “clean-label” movement is a consumer movement or trend driven by health and nutrition conscious consumers. The term “clean-label” is a term that has been adopted by the food industry, consumers, academics, and governmental regulatory agencies. A “clean-label” product is a food product that contains as few ingredients as possible, and which are generally recognized as natural, familiar, and simple ingredients. Consumers and the general public consider, perceive, or recognize the ingredients in the “clean-label” product as being healthy or wholesome, and not artificial, processed, synthetic, or to contain chemicals.

In certain embodiments, the consumable is selected from the group consisting of non-dairy milk, non-dairy coffee creamer, non-dairy yogurt, non-dairy cream cheese, non-dairy cream or non-dairy cheese.

In certain embodiments, the at least one inorganic salt and/or inorganic chelate of calcium with potassium citrate is present in the consumable in an amount of from about 0).001% to about 10%, based on the total weight of the consumable. In certain embodiments, the at least one inorganic salt and/or inorganic chelate of calcium with potassium citrate is present in the consumable in an amount of from about 0.01% to about 5%, based on the total weight of the consumable. In certain embodiments, the at least one inorganic salt and/or inorganic chelate of calcium with potassium citrate is present in the consumable in an amount of from about 0.1% to about 2%, based on the total weight of the consumable. In certain embodiments, the at least one inorganic salt and/or inorganic chelate of calcium with potassium citrate is present in the consumable in an amount of from about 0.01% to about 5%, or 0).01% to about 4%, or 0.01% to about 3%, or 0.1% to about 2%, or 0.1% to about 1.5%, or 0.5% to about 1%, based on the total weight of the consumable.

In certain embodiments, the edible non-animal protein base is present in the consumable in an amount of from about 1% to about 20%, based on the total weight of the consumable. In certain embodiments, the edible non-animal protein base is present in the consumable in an amount of from about 2% to about 15%, based on the total weight of the consumable. In certain embodiments, the edible non-animal protein base is present in the consumable in an amount of from about 3% to about 10%, based on the total weight of the consumable. In certain embodiments, the edible non-animal protein base is present in the consumable in an amount of from about 4% to about 8%, based on the total weight of the consumable. The consumable containing the composition may deliver about 8 to 10 grams of protein per 8 ounce serving.

In certain embodiments, the consumable containing the composition further includes a protein binder in an amount of from about 0.001% to about 5%, or from about 0.001% to about 1%, or from about 0.001% to about 0).1%, based on the total weight of the consumable.

In certain embodiments, the consumable containing the composition further includes a non-animal fat in an amount of from about 0.1% to about 10%, or from about 0).5% to about 5%, or from about 1% to about 2%, based on the total weight of the consumable.

In certain embodiments, the consumable containing the composition further includes at least one sweetener in an amount of from about 0).1% to about 10%, or from about 0.5% to about 5%, or from about 1% to about 3%, based on the total weight of the consumable.

In certain embodiments, the consumable containing the composition further includes beta glucan in an amount of from about 0.001% to about 5%, or from about 0.01% to about 2.5%, or from about 0).35% to about 1%, based on the total weight of the consumable.

In certain embodiments, the consumable containing the composition further includes at least one flavorant in an amount of from about 0.001% to about 5%, or from about 0.01% to about 2.5%, or from about 0).1% to about 2%, based on the total weight of the consumable.

In certain embodiments, the consumable containing the composition further includes at least one organic acid in an amount of from about 0.001% to about 5%, or from about 0.01% to about 2.5%, or from about 0).3% to about 2%, based on the total weight of the consumable.

It has surprisingly been found that a consumable containing the composition provides an improved calcium solubility and bioavailability as compared to compositions containing at least one inorganic salt and/or inorganic chelate of calcium without potassium citrate on a weight-by-weight basis. In certain embodiments, a consumable containing the composition provides about 100 mg to about 400 mg of calcium per 240 ml serving of the consumable. In certain embodiments, a consumable containing the composition provides about 150 mg to about 350 mg of calcium per 240 ml serving of the consumable. In certain embodiments, a consumable containing the composition provides about 200 mg to about 325 mg of calcium per 240 ml serving of the consumable. In certain embodiments, a consumable containing the composition provides about 250 mg to about 300 mg of calcium per 240 ml serving of the consumable. In certain embodiments, a consumable containing the composition provides about 300 mg of calcium per 240 ml serving of the consumable.

In certain embodiments, the consumable containing the composition is free of calcium salts other than the at least one inorganic salt and/or inorganic chelate of calcium with potassium citrate. In certain embodiments, the consumable containing the composition is free of calcium ascorbate, calcium carbonate, calcium sulfate, calcium lactate, calcium lactate gluconate, calcium acetate, calcium chloride, and/or calcium hydroxide.

Additionally disclosed is a method for preparing a consumable. The method for preparing the consumable comprises adding to a consumable base at least one inorganic salt and/or inorganic chelate of calcium with potassium citrate and at least one organic acid. The at least one inorganic salt and/or inorganic chelate of calcium with potassium citrate and the at least one organic acid are added to the consumable base in amounts to provide a taste and mouthfeel reminiscent of a dairy product and to provide at least the same amount of bioavailable calcium as a dairy product on a weight-by-weight basis.

Also disclosed is a method of modifying the taste or flavor of a consumable comprising non-animal derived ingredients, wherein the method provides a taste and mouthfeel reminiscent of a dairy product, wherein the method comprises adding to the consumable a composition comprising at least one inorganic salt and/or inorganic chelate of calcium with potassium citrate and at least one organic acid, wherein the composition is free of animal-derived ingredients.

Also disclosed is a method of imparting a taste or flavor reminiscent of dairy to a consumable, the method comprising the step of incorporating into the consumable, which is free of dairy, a composition comprising at least one inorganic salt and/or inorganic chelate of calcium with potassium citrate and at least one organic acid, wherein the composition is free of animal-derived ingredients.

### EXAMPLES

The following examples are given solely for the purpose of illustration and are not to be construed as limitations of the present disclosure, as many variations of the invention are possible without departing from the spirit and scope of the present disclosure.

Six identical pea milk beverages were prepared using 4.65% pea protein isolate (VITESSENCE® Pulse 1853 supplied by Ingredion Incorporated), based on the total weight of the beverage. Six separate calcium fortifying compositions were added to each of the beverages. The compositions were the same except they included different calcium salts. In particular, comparative Composition 1 included tri-calcium phosphate: comparative Composition 2 included calcium carbonate: comparative Composition 3 included calcium lactate: comparative Composition 4 included calcium chloride: comparative Composition 5 included calcium hydroxide; and inventive Composition 6 included calcium potassium phosphate citrate.

Sensory evaluation of each of the beverages was carried out with eight trained expert panelists. The entire panel overwhelmingly concluded that:
The beverages containing comparative Compositions 1-5 exhibited poor “grainy” mouthfeel, indicating that these calcium salts exhibited poor solubility.
The beverage containing comparative Composition 4 also contained undesirable precipitated calcium salts after ultrapasteurizing.
The beverage containing comparative Composition 5 also exhibited unpleasant cooked egg white aroma off-notes after ultrapasteurizing.
The calcium salts in the beverage containing inventive Composition 6 dissolved readily: no unpleasant aroma off-notes were present even after ultrapasteurizing: slight astringency reminiscent of dairy milk.

These findings were particularly surprising as one of ordinary skill in the art would expect that all calcium salts would possess similar properties. The main nutritional values (in grams) based on a 240-gram serving of a beverage containing inventive Composition 6 was also compared to a 2% fat dairy milk beverage, as shown in Table 1 below.

TABLE 1

| Example | protein | fat | sugar | Carbs | Calories | Calcium |
|---|---|---|---|---|---|---|
| Pea Milk | 9.126 | 4.917 | 3.840 | 4.235 | 97.698 | 0.315 |
| containing | | | | | | |
| inventive | | | | | | |
| Composition 6 | | | | | | |
| 2% Fat Dairy | 9.000 | 4.990 | 12.000 | 13.000 | 130.000 | 0.309 |
| Milk | | | | | | |

As shown in Table 1, the main nutritional values of the beverage containing inventive Composition 6 were superior to a 2% fat dairy milk beverage. In particular, the beverage containing inventive Composition 6 provided a higher amount of protein and calcium, and a lower amount of fat, sugar, carbohydrates, and calories, as compared to a 2% fat dairy milk beverage.

An illustrative pea milk beverage formulation containing the composition is shown in Table 2 below.

TABLE 2

| Ingredients | (wt %) |
|---|---|
| Pea protein isolate¹ | 4.65 |
| Protein binder | 0.0008 |
| MCT oil² | 1.7 |
| Sucrose | 1.6 |
| Calcium phosphate potassium citrate | 0.730 |
| Beta glucan³ | 0.035 |
| Milk Flavor⁴ | 0.120 |
| Organic acid | 0.500 |
| Water | 90.65 |

¹VITESSENCE ® Pulse 1853 available from Ingredion Incorporated.
²medium chain triglyceride obtained from coconut oil available from Nutiva, Inc.
³SWEOAT ™ Bran BG28 available from Naturex SA.
⁴Milk flavorant available from Givaudan Flavors Corp.

The illustrative pea milk beverage formulation of Table 2 was prepared according to the following method. Pea protein isolate, protein binder and water (55%) was subjected to a shear mixing treatment with an electric immersion mixer and maintained at 100-150° F. on a hot plate with constant stirring for 15 minutes. Water (40%) was separately added to coconut oil in an inner container of a double boiler. Beta glucan, calcium phosphate potassium citrate, and sucrose was separately mixed and then added to the coconut oil mixture and subsequently mixed with electric immersion mixer. The two liquids were then mixed in the double boiler and rinsed with water (5%). Milk flavor was added and then the mixture was heated to 150° F. The mixture was then homogenized with Silverson L5M-A, smallest hole head, at 10,000 rpm for 2 minutes. The mixture was then subjected to ultrahigh temperature (UHT) direct steam treatment for 6 second hold at 141° C. and homogenized 500/3,500 psi, and then cooled quickly and refrigerated.

An illustrative calcium fortifying composition in liquid form is shown in Table 3 below.

TABLE 3

| Ingredients | (wt %) |
|---|---|
| Protein binder | 0.08 |
| MCT oil¹ | 25.8 |
| Organic acid | 5.0 |
| Calcium phosphate potassium citrate | 7.3 |
| Beta glucan² | 0.35 |
| Milk Flavor³ | 1.2 |
| Carbohydrate component (potato starch) | 60.27 |

¹medium chain triglyceride obtained from coconut oil available from Nutiva, Inc.
²SWEOAT ™ Bran BG28 available from Naturex SA.
³Milk flavorant available from Givaudan Flavors Corp.

It should be understood that when a range of values is described in the present disclosure, it is intended that any and every value within the range, including the end points, is to be considered as having been disclosed. For example, “a range of from 50 to 100” of a component is to be read as indicating each and every possible number along the continuum between 50 and 100. It is to be understood that the inventors appreciate and understand that any and all values within the range are to be considered to have been specified, and that the inventors have possession of the entire range and all the values within the range.

The compositional weight percentages disclosed herein are based on the total weight of the composition or consumable, as the situation dictates. It will be understood to one of ordinary skill in the art that the total weight percent of the compositions and consumable cannot exceed 100%. For example, a person of ordinary skill in the art would easily recognize and understand that a composition comprising xa to ya weight percent of at least one inorganic salt and/or inorganic chelate of calcium with potassium citrate and xb to yb weight percent of at least one organic acid will not exceed 100%. A person of ordinary skill in the art would understand that the amount of the components may be adjusted to include the desired amount of component without exceeding 100% by weight of the composition or consumable.

In the present disclosure, the term “about” used in connection with a value is inclusive of the stated value and has the meaning dictated by the context. For example, it includes at least the degree of error associated with the measurement of the particular value. One of ordinary skill in the art would understand the term “about” is used herein to mean that an amount of “about” of a recited value produces the desired degree of effectiveness in the compositions and/or methods of the present disclosure. One of ordinary skill in the art would further understand that the metes and bounds of “about” with respect to the value of a percentage, amount or quantity of any component in an embodiment can be determined by varying the value, determining the effectiveness of the compositions for each value, and determining the range of values that produce compositions with the desired degree of effectiveness in accordance with the present disclosure. The term “about” is further used to reflect the possibility that a composition may contain trace components of other materials that do not alter the effectiveness or safety of the composition.

As used in this specification, the terms “comprises.” “comprising.” “contains,” “containing.” “includes,” “including.” “has.” or “having.” are all open-ended expressions and are intended to cover apparatus, compositions, methods, processes, products, or systems that comprise a recited list of components, elements, and features, and any and all additional components, elements and features that are not expressly recited. The terms “includes.” “including.” “has,” or “having” are not intended to have a more narrow construction. interpretation, or meaning than the terms “comprises” or “comprising.”

As used in the present specification, the term “or” refers to an inclusive “or” and not to an exclusive “or”. For example, the phrase “A or B” is satisfied by any one of the following: A is present and B is not present, A is not present and B is present, and both A and B are present.

As used in the present specification, “a” or “an” is employed to describe components, elements, features and method/process steps of various illustrative embodiments disclosed herein. The use of “a” or “an” should be interpreted to include one or more than one.

As used in the present specification, any of the terms “illustratively,” “preferably.” “commonly.” and “typically” are not intended to, and do not, limit the scope of the claimed embodiments, or to imply that certain features are critical, essential, important, or required to the structure or function of the claimed computer system or computer-implemented method. Rather, these terms are merely intended to identify particular aspects of an embodiment or to emphasize alternative or additional features that may or may not be utilized in a particular embodiment.

While the compositions, process for making for the compositions, process for using the compositions, and the consumables have been described above in connection with certain illustrative embodiments, it is to be understood that other embodiments may be used or modifications and additions may be made to the described embodiments for performing the same function of the present embodiments without deviating therefrom. Further, all embodiments disclosed are not necessarily in the alternative, as various embodiments of the invention may be combined to provide the desired characteristics. Variations can be made by one having ordinary skill in the art without departing from the spirit and scope of the disclosure. Therefore, the present disclosure should not be limited to any single embodiment, but rather construed in breadth and scope in accordance with the recitation of the attached claims.

1. A composition comprising:
(a) at least one inorganic salt and/or inorganic chelate of calcium with potassium citrate; and
(b) at least one organic acid;
wherein the composition is free of animal-derived ingredients, wherein the composition, when incorporated into a non-dairy consumable, provides at least the same amount of bioavailable calcium as a dairy consumable on a weight-by-weight basis, and wherein the composition provides a taste and mouthfeel reminiscent of a dairy consumable.

2. The composition according to claim 1, wherein the at least one inorganic salt and/or inorganic chelate of calcium comprises monocalcium phosphate, dicalcium phosphate, and/or tricalcium phosphate.

3. The composition according to claim 1, wherein the composition further comprises at least one of: a flavorant, a non-animal fat, a protein binder, a plant-derived protein, or a carbohydrate component.

4. The composition according to claim 1, wherein the composition is free of calcium salts other than the at least one inorganic salt and/or inorganic chelate of calcium with potassium citrate.

5. The composition according to claim 1, wherein the composition comprises from 1% to 20% by weight of the at least one inorganic salt and/or inorganic chelate of calcium with potassium citrate.

6. The composition according to claim 1, wherein the composition is free of a gum.

7. The composition according to claim 6, wherein the composition further comprises beta glucan.

8. A non-dairy consumable comprising an edible non-animal protein base and the composition according to claim 1, wherein the consumable is free of animal-derived ingredients, wherein the consumable provides a taste and mouthfeel reminiscent of a dairy product, and wherein the consumable provides at least the same amount of bioavailable calcium as a dairy product on a weight-by-weight basis.

9. The consumable according to claim 8, wherein the consumable is a clean-label dairy alternative beverage.

10. The consumable according to claim 8, wherein the consumable is non-dairy milk, non-dairy coffee creamer, non-dairy yogurt, non-dairy cream cheese, non-dairy cream or non-dairy cheese.

11. The consumable according to claim 8, wherein the edible non-animal protein base comprises at least one of beans, broccoli, mycoprotein, nuts, faba, coconuts, peas, soy, potatoes, oats, chickpea, coconuts, seeds plant leaf proteins, cereal, or tofu.

12. The consumable according to claim 11, wherein the beans comprise at least one of black beans, faba beans, canelli beans, kidney beans, lentil beans, lima beans, pinto beans, soy beans, white beans, mung beans; wherein the nuts comprise at least one of almonds, brazil nuts, cashews, peanuts, pecans, hazelnuts, pine nuts, walnuts; wherein the peas comprise at least one of black eyed peas, chickpeas, green peas; wherein the seeds comprise at least one of chia, flax, hemp, pumpkin, sesame, sunflower; and wherein the cereal comprises at least one of oat, wheat, barley, spelt, corn, rice.

13. The consumable according to claim 8, wherein the consumable provides at least 300 mg calcium per 240 ml serving of the consumable.

14. The consumable according to claim 8, wherein the consumable further comprises a protein binder and a non-animal fat.

15. The consumable according to claim 14, wherein the non-animal fat comprises medium chain triglyceride oil obtained from coconut oil.

16. The consumable according to claim 8, wherein the consumable further comprises a sweetener, wherein the sweetener comprises a natural sweetener selected from: sucrose, high fructose corn syrup, fructose and glucose, or a high intensity, non-nutritive sweetener selected from: aspartame, acesulfame K, sucralose, cyclamate, sodium saccharin, neotame, rebaudioside A, and/or other stevia-based sweeteners.

17. The consumable according to claim 8, wherein the consumable is free of calcium salts other than the at least one inorganic salt and/or inorganic chelate of calcium with potassium citrate.

18. The consumable according to claim 8, wherein the consumable further comprises beta glucan.

19. A method of modifying the taste or flavor of a clean-label dairy alternative consumable comprising non-animal derived protein, wherein the method provides a taste and mouthfeel reminiscent of a dairy product, wherein the method comprises adding to the consumable the composition according to claim 1.

20. A method of imparting a taste or flavor reminiscent of dairy to a clean-label dairy alternative consumable, the method comprising the step of incorporating into the consumable the composition according to claim 1.
